(19) United States
(12) Patent Application Publication
(10) Pub. No.: US 2018/0131769 A1
(43) Pub. Date: May 10, 2018

(54) Operating Room Decentralized Smart Controller Network

(71) Applicants: Oliver WELTER, Berlin (DE); Udo WARSCHEWSKE, Berlin (DE); Nazim AKMANDIL, Berlin (DE); Dennis KOGAN, Berlin (DE); Bjoern VON SIEMENS, Berlin (DE)

(72) Inventors: Oliver WELTER, Berlin (DE); Udo WARSCHEWSKE, Berlin (DE); Nazim AKMANDIL, Berlin (DE); Dennis KOGAN, Berlin (DE); Bjoern VON SIEMENS, Berlin (DE)

(21) Appl. No.: 15/809,862

(22) Filed: Nov. 10, 2017

Related U.S. Application Data
(60) Provisional application No. 62/420,357, filed on Nov. 10, 2016.

(51) Int. Cl. H04L 29/08; H04L 12/24

(52) U.S. Cl. CPC H04L 67/125; H04L 67/025; H04W 4/005; H04L 41/0816; H04L 67/16

(57) ABSTRACT

A system for decentralized control of fixtures in a medical care facility according to an embodiment of the present disclosure includes a first controller configured to physically and communicably couple with a first device and a network, the first device physically coupled to, or self-contained in a sterile environment within, a medical care facility and configured to affect or observe physical conditions of the facility; a second controller configured to physically and communicably couple with a second device and the network, the second device physically coupled to, or self-contained in a sterile environment within, the medical care facility and configured to affect or observe physical conditions of the facility; and a message broker communicably coupled to the network and to the first and second controllers, the message broker configured to receive messages sent by the first controller and the second controller and to broadcast messages to the network.

### CROSS-REFERENCE TO RELATED APPLICATIONS

This application claims the benefit of U.S. Provisional Patent Application Ser. No. 62/420,357, filed on Nov. 10, 2016, which is incorporated by reference herein in its entirety for all purposes.

### BACKGROUND

Numerous legacy devices populate medical care facilities, for example lights and cameras in hospital operating rooms. Many such legacy devices are not network enabled, and/or do not communicate with other fixture-type devices in the operating room even though their operation directly or indirectly impacts the desirable settings or parameters for the other devices.

Installing proprietary networked “smart” devices that are centrally controlled can be expensive, and the central control makes such systems more vulnerable to failure when the central controller (e.g. the central server) becomes non-operational.

### SUMMARY

A system for decentralized control of fixtures in a medical care facility according to an embodiment of the present disclosure includes a first controller configured to physically and communicably couple with a first device and communicably coupled to a network, the first device physically coupled to, or self-contained in a sterile environment within, a medical care facility and configured to affect or observe physical conditions of the medical care facility; a second controller configured to physically and communicably couple with a second device and communicably coupled to the network, the second device physically coupled to, or self-contained in a sterile environment within, the medical care facility and configured to affect or observe physical conditions of the medical care facility; and a message broker communicably coupled to the network and to the first and second controllers, the message broker configured to receive all messages sent by the first controller and the second controller and to broadcast any such messages to the network; the first controller configured for autonomous operation, the first controller is configured to: control operation of the first device; observe parameter changes in the first device; receive messages broadcast by the message broker and determine, for each message, whether the first controller has instructions for controlling the operation of the first device based on the message, and based on an affirmative determination, controlling the first device based on the message; and send messages to the message broker indicative of the parameter changes in the first device; the second controller configured for autonomous operation, the second controller is configured to: control operation of the second device; observe parameter changes in the second device; receive messages broadcast by the message broker and determine, for each message, whether the second controller has instructions for controlling the operation of the second device based on the message, and based on an affirmative determination, controlling the second device based on the message; and send messages to the message broker indicative of the parameter changes in the second device.

The system of paragraph [0004], wherein the first controller is independent of the second controller and is configured to operate regardless of a presence of the second controller.

The system of any of paragraphs [0004] to [0005], wherein the network is a local area network in the medical care facility.

The system of any of paragraphs [0004] to [0006], further comprising the first device physically and communicably coupled to the first controller, wherein the first device is communicably coupled to the network only via the first controller.

The system of any of paragraphs [0004] to [0007], further comprising the second device physically and communicably coupled to the second controller, wherein the second device is communicably coupled to the network only via the second controller.

The system of any of paragraphs [0004] to [0008], wherein the first device is a lighting fixture configured to light at least a portion of the medical care facility.

The system of any of paragraphs [0004] to [0009], wherein the second device is a camera configured to capture images of the at least the portion of the medical care facility.

The system of any of paragraphs [0004] to [0010], wherein the parameter changes in the first device comprise a change in light intensity, and wherein the first controller is configured to send a message to the message broker indicating the change in light intensity, wherein the message broker is configured to broadcast the message, and wherein the second controller is configured to: determine that the second controller has instructions for controlling the operation of the camera based on the message, and adjust a lighting compensation parameter of the camera based on the message.

A controller for decentralized control of fixtures in a medical care facility, according to an embodiment of the present disclosure, includes a housing that is self-contained in a sterile environment of the medical care facility; a network interface contained by the housing, the network interface configured to communicably couple with a network; a device interface contained by the housing, the device interface configured to physically and communicably couple with a device that is physically coupled to, or self-contained in a sterile environment in, a medical care facility and configured to affect or observe physical conditions of the medical care facility; a processor communicably coupled to the network interface, the device interface, and a memory, the processor configured for autonomous operation, the memory including instructions that, when executed by the processor, cause the processor to: receive a broadcast message from the network via the network interface; determine whether the instructions include instructions for controlling the operation of the device based on the message; based on an affirmative determination, adapting the message to an adapted message in a protocol that is specific to the device; and controlling the device by sending the adapted message to the device via the device interface.

A method for decentralized control of fixtures in a medical care facility according to an embodiment of the present disclosure includes physically and communicably coupling a first controller to a first device and communicably coupling the first controller to a network, the first device physically coupled to, or self-contained in a sterile environment within, a medical care facility and configured to affect or observe physical conditions of the medical care facility; physically and communicably coupling a second controller configured to a second device and communicably coupling the second controller to the network, the second device physically coupled to, or self-contained in a sterile environment within, the medical care facility and configured to affect or observe physical conditions of the medical care facility; and communicably coupling a message broker to the network and to the first and second controllers, the message broker configured to receive all messages sent by the first controller and the second controller and to broadcast any such messages to the network; receiving messages broadcast by the message broker at the first controller, and determining, for each message, whether the first controller has instructions for controlling the operation of the first device based on the message, and based on a positive determination, controlling the first device based on the message; receiving messages broadcast by the message broker at the second controller, and determining, for each message, whether the second controller has instructions for controlling the operation of the second device based on the message, and based on a positive determination, controlling the second device based on the message, wherein the first and second controllers operate autonomously, redundantly and without reliance on one another, by listening for and processing messages from the message broker, and by publishing messages to the message broker indicative of operation of their respective first and second devices.

The method of any of paragraphs [0004] to [0013], wherein the network is a local area network in the medical care facility.

The method of any of paragraphs [0004] to [0014], further comprising communicably coupling the first device to the network only via the first controller.

The method of any of paragraphs [0004] to [0015], further comprising communicably coupling the second device to the network only via the second controller.

The method of any of paragraphs [0004] to [0016], wherein the first device is a lighting fixture configured to light at least a portion of the medical care facility.

The method of any of paragraphs [0004] to [0017], wherein the second device is a camera configured to capture images of the at least the portion of the medical care facility.

The method of any of paragraphs [0004] to [0018], further comprising: publishing a message to the network with the first controller indicating a change in light intensity of the lighting fixture; receiving the message with the message broker; broadcasting the message to the network with the message broker; receiving the broadcast message at the second controller; determining that the second controller has instructions for controlling the operation of the camera based on the message, and adjust a lighting compensation parameter of the camera based on the message.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a top plan view of a hospital operating room, according to one embodiment of the present disclosure.

FIG. 2 illustrates a first portion of a smart controller network, according to embodiments of the present disclosure.

FIG. 3 illustrates a second portion of the smart controller network of FIG. 2, according to embodiments of the present disclosure.

FIG. 4 illustrates a software architecture for a smart controller network, according to embodiments of the present disclosure.

FIG. 5 illustrates a hardware deployment diagram for the smart controller network of FIG. 4, according to embodiments of the present disclosure.

FIG. 6 illustrates a smart controller network for an operating room light, a button, and an operating room camera, according to an embodiment of the present disclosure.

FIG. 7 illustrates a messaging diagram for an interaction among the smart controllers of FIG. 6, according to an embodiment of the present disclosure.

FIG. 8 illustrates a messaging diagram for another interaction among smart controllers, according to an embodiment of the present disclosure.

FIG. 9 illustrates a user interface control for a universal keypad in an operating room environment, according to an embodiment of the present disclosure.

FIG. 10 illustrates a user interface control for a universal keypad in an operating room environment, according to an embodiment of the present disclosure.

FIG. 11 illustrates a user interface control for a universal keypad in an operating room environment, according to an embodiment of the present disclosure.

FIG. 12 illustrates a user interface control for a universal keypad in an operating room environment, according to an embodiment of the present disclosure.

FIG. 13 illustrates a user interface control for a universal keypad in an operating room environment, according to an embodiment of the present disclosure.

FIG. 14 illustrates a user interface control for a universal keypad in an operating room environment, according to an embodiment of the present disclosure.

FIG. 15 illustrates a user interface control for a universal keypad in an operating room environment, according to an embodiment of the present disclosure.

FIG. 16 illustrates a user interface control for a universal keypad in an operating room environment, according to an embodiment of the present disclosure.

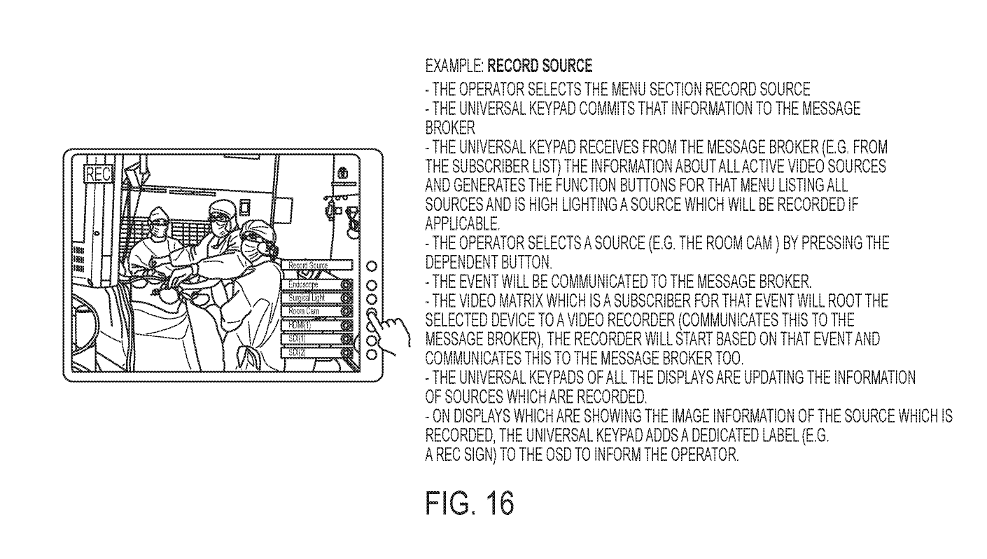

While embodiments of the disclosure are amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

A smart hospital network according to an embodiment of the present disclosure includes a distributed network containing autonomous and semi-autonomous systems ranging from simple trigger emitter like pressed hardware buttons to fully operational web based content management systems. According to embodiments, the underlying infrastructure is based on the principle that all systems are participants in the same network with the ability to communicate to every other system allowing flexible and dynamic setups. Instead of routing low level data from devices to a central unit for interpretation and integration, specialized embedded devices take over responsibility for interpretation and adaption of data providing semantically enriched information within the network, according to some embodiments. Since the data itself and the procession is distributed within the network scalability, redundancy and sharing can be achieved more easily compared to a single information sink or central server/repository solutions. Accessing data is possible by connecting to the network even without knowledge of the existence of the data sources. The network itself becomes the data source, comparable to neural networks in some embodiments.

According to some embodiments of the present disclosure, implementation of a smart hospital network incorporates three principles: SoS: System of Systems; Microservices; and IoT: Internet of Things. According to Wikipedia and other sources, a system of Systems is based on the idea that the whole is greater than the sum of its parts, taking synergy effects and workflow efficiency into consideration. Many complex systems include multiple systems using standardized or proprietary interfaces for integration. This is often driven by vendor and product varieties within the market creating demand for integration solutions. Even if the potential benefit of combining highly specified systems with each other is recognized, in practice most systems of systems suffer from poor integration because integration with third party systems is an afterthought by most vendors. In addition to this, regulatory constraints raise the bar for integration even higher, which leads to a demand for more robust integration concepts. Microservice architecture on a software level and IoT for hardware integration are considered powerful approaches to build reliable, flexible and efficient systems of systems, according to embodiments of the present disclosure.

According to Wikipedia and other sources, microservices break down complex workflows and functionality into separate services using defined interfaces. In contrast to the general concept of modularization in software engineering, microservices take distributed computing into consideration in a way that each microservice can be allocated to a different execution environment supporting redundancy and scalability. Since microservices are decoupled it is also possible to wire them up flexibly during runtime and react to infrastructure changes or upcoming customer demands. For development of stable microservices, the APIs used internally are often well designed and documented, leading to the positive side effect that internal application programming interfaces (APIs) can be published more easily compared to monolithic structures supporting third party integration. As the use of web based applications running within a browser increases steadily, HTTP running on top of TCP/IP may be viewed as a desirable selection for communication interfaces, according to some embodiments of the present disclosure.

According to Wikipedia and other sources, the internet of things (IoT) relates to the concept that each and every device is connected within a ubiquitous network supporting flexible network topologies and communication partners. Each IoT device possesses the ability to process data on its own to provide enriched information to the network, according to embodiments of the present disclosure. IoT heavily relies on interconnectivity, therefore a challenge with such devices is often the creation and maintenance of the ubiquitous network and provision of access to all devices. Together with the rise of the internet, the underlying TCP/IP protocol became the most popular and flexible solution for generic network infrastructures. As a consequence, TCP/IP can also be used on top of several other networks like ATM (which is mainly used in telephone networks). Therefore, TCP/IP has become the prevalent protocol for data transmission. This is also stressed by current attempts of a variety of industries to migrate their specialized data transmission technologies to TCP/IP infrastructures (e.g. video over IP, bus systems in automobiles, and the like). As a result, IoT is closely connected to the approach to extend devices with a TCP/IP network stack. Since TCP/IP is very generic, additional application oriented protocols are built on top of it (e.g. MQTT or HTTP) for more sophisticated communication scenarios, according to embodiments of the present disclosure.

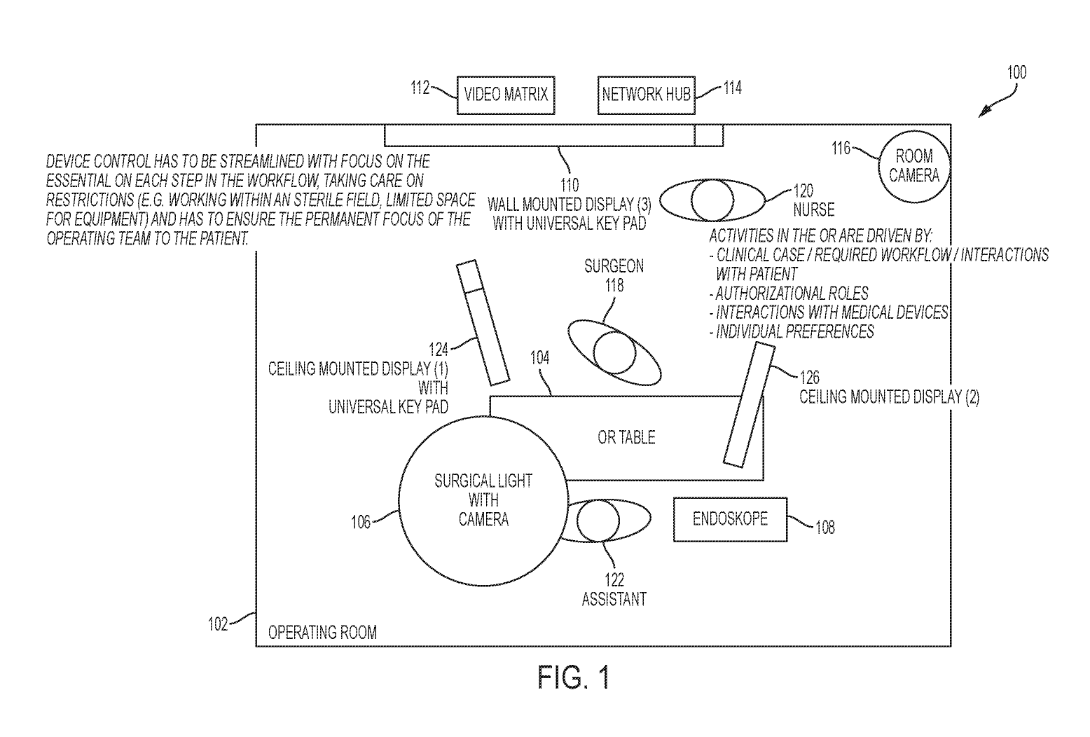

FIG. 1 illustrates a top plan view of a hospital operating room system 100, according to one embodiment of the present disclosure. The room system 100 includes a room 102, for example an operating room. The operating room includes one or more devices, for example an operating room table 104, a surgical light with a camera 106, an endoscope 108, a wall-mounted display with a universal keypad 110, a video matrix 112, a network hub 114, a room camera 116, and ceiling mounted display units 124, 126, which are configured and/or arranged for use by one or more users, for example a surgeon 118, a nurse 120, and/or an assistant 122.

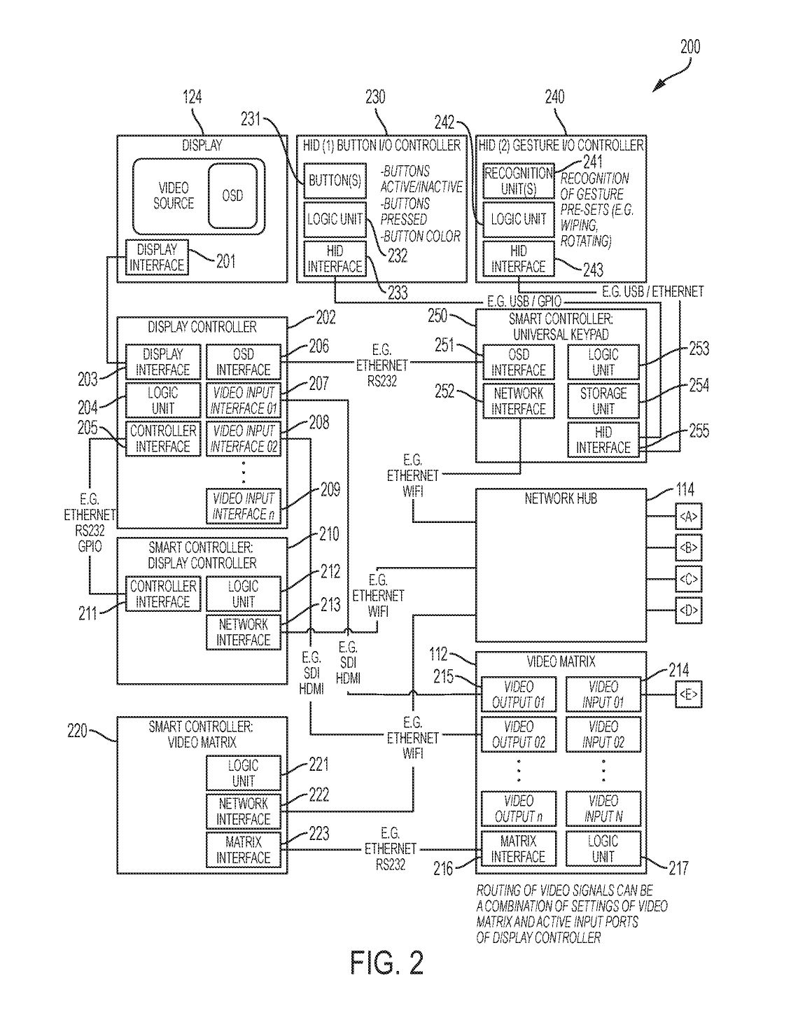

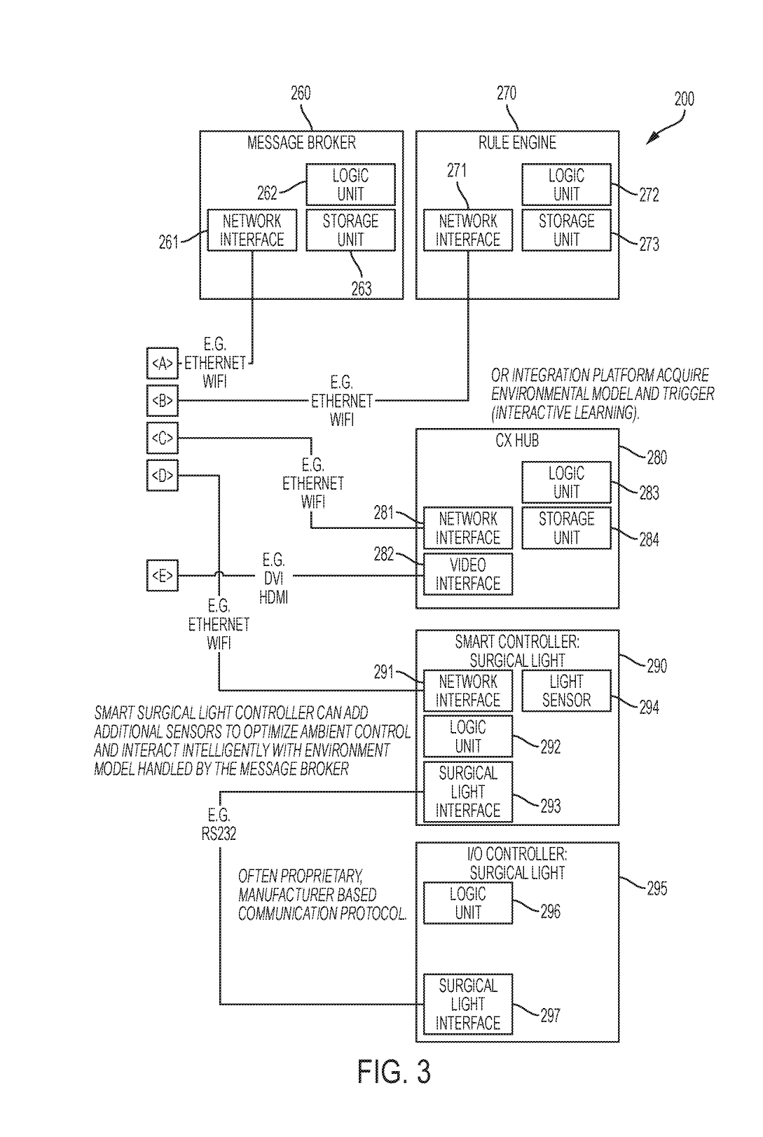

FIGS. 2 and 3 illustrate a smart controller network 200, according to embodiments of the present disclosure. Smart controller network 200 may be implemented on or with one or a combination of devices illustrated in FIG. 1, according to some embodiments. System 200 includes various devices, including controllers and hubs. For example, system 200 includes a network hub 114, a display device 124, a display controller 202, a smart controller 210 for the display controller 202, a video matrix 112, a smart controller 220 for the video matrix 212, a human interface device button input/output controller 230, a human interface device gesture input/output controller 240, a smart controller 250 for a universal keypad, a message broker 260, a rule engine 270, a communication hub 280, a smart controller 290 for a surgical light, and an input/output controller 295 for a surgical light, according to embodiments of the present disclosure. Devices may include one or more interfaces and/or one or more logic units, according to embodiments of the present disclosure. For example, display device 124 may include a video source, for example a video source with an on-screen display (OSD), and a display interface 201. The display controller 202 may include a display interface 203 communicably coupled to display interface 201, a logic unit 204, a controller interface 205, an OSD interface 206, and one or more video input interfaces 207, 208, 209, according to embodiments of the present disclosure. The smart controller 210 may include a controller interface 211 communicably coupled to controller interface 205, a logic unit 212, and a network interface 213, according to embodiments of the present disclosure.

The video matrix 112 may include one or more video outputs 215, communicably coupled to the one or more video input interfaces 207, 208, one or more video inputs 214, a logic unit 217, and a matrix interface 216 communicably coupled to matrix interface 223, according to embodiments of the present disclosure. The HID button input/output controller 230 may include one or more buttons 231, a logic unit 232, and an HID interface 233, according to embodiments of the present disclosure. The HID gesture input/output controller 240 may include one or more recognition units 241, a logic unit 242, and an HID interface 243, according to embodiments of the present disclosure. The smart controller 250 for the universal keypad may include an OSD interface coupled to OSD interface 206, a network interface 252, a logic unit 253, a storage unit 254, and an HID interface 255 communicably coupled to HID interfaces 233 and 243, according to embodiments of the present disclosure. A message broker 260 may include a network interface 261, a logic unit 262, and a storage unit 263, according to embodiments of the present disclosure. The rule engine 270 may include a network interface 271, a logic unit 272, and a storage unit 273, according to embodiments of the present disclosure. The communications hub 280 may include a network interface 281, a video interface 282 communicably coupled to the one or more video inputs 214, a logic unit 283, and a storage unit 284, according to embodiments of the present disclosure. The smart controller 290 includes a network interface 291, a logic unit 292, a light sensor 294, and a surgical light interface 293, according to embodiments of the present disclosure. The input/output controller 295 includes a logic unit 296, and a surgical light interface 297 communicably coupled to surgical light interface 293, according to embodiments of the present disclosure. The network hub 114 is communicably coupled to network interfaces 252, 213, 222, 261, 271, 281, and 291, according to embodiments of the present disclosure.

Based on the disclosure provided herein, one of ordinary skill in the art will appreciate that the functionality of the hardware described may be included in a fewer or greater number of hardware devices, or be located on different devices, and/or distributed across multiple devices, and the software described herein may be included on different devices, in different arrangements, and/or distributed across multiple devices and/or in the network (or “cloud”).

Elements of system 200 that are connected by solid lines or grouped by boxes are communicably coupled to one another, according to embodiments of the present disclosure. Non-limiting examples of such communicable coupling connections are provided in FIGS. 2 and 3, including the non-limiting examples of Ethernet, WiFi, RS232, DVI, and HDMI. Though solid lines are used to represent example communicable couplings, such communicable coupling may include one or a combination of wired, wireless, optical, and any other connection, direct or indirect, that permits information or data to be communicated. Also, additional communicable couplings or fewer communicable couplings may be present among each, or all, or any combination or subcombination, of the devices, interfaces, and/or units, compared to those specifically shown in FIGS. 2 and 3. The legends <A>, <B>, <C>, <D>, and <E> show communicable couplings extending across both FIGS. 2 and 3.

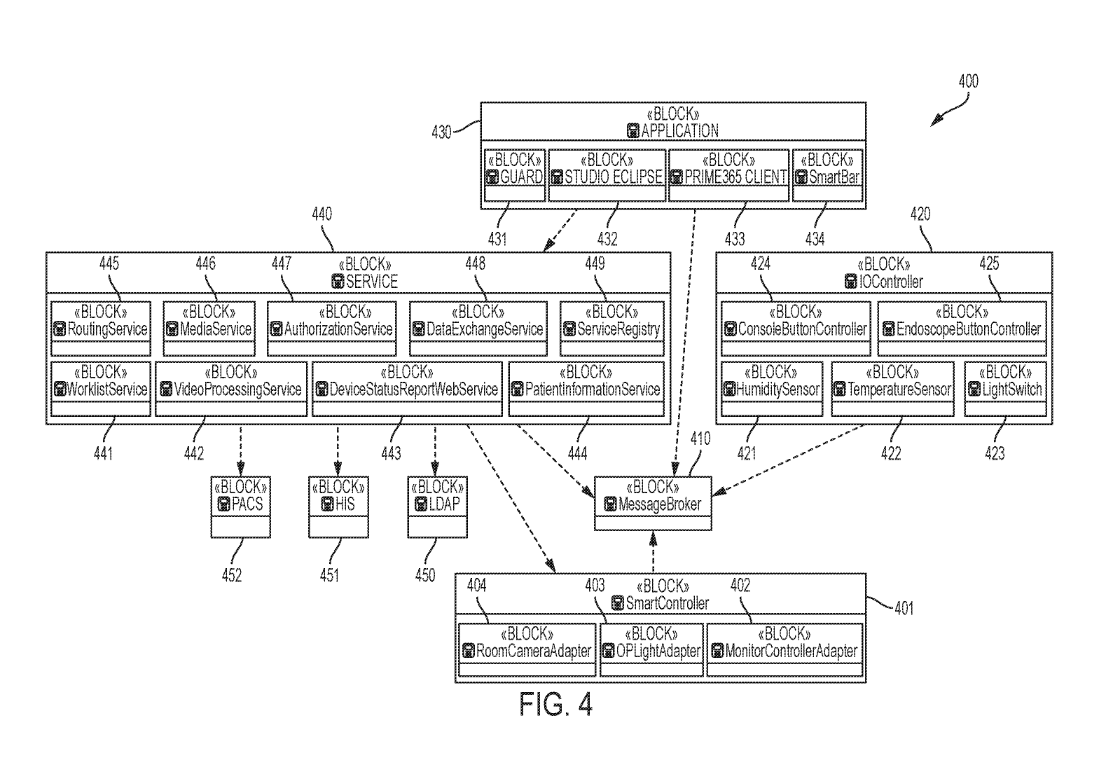

FIG. 4 illustrates a software architecture 400 for a smart controller network, according to embodiments of the present disclosure. The software architecture 400 includes an application layer 430, an input/output controller layer 420, a service layer 440, a message broker layer 410, and a smart controller layer 401, according to embodiments of the present disclosure. Examples of applications that may be included in the application layer 430 are a Guard application 431, a Studio Eclipse application 432, a Prime365 client 433, and/or a SmartBar application 434, all of which are applications available from S-CAPE GmbH of Germany, according to embodiments of the present disclosure. Examples of input/output controller instances in layer 420 may include a console button controller 424, an endoscope button controller 425, a humidity sensor controller 421, a temperature sensor controller 422, and a light switch 423, according to embodiments of the present disclosure. The smart controller layer 401 may include a room camera adapter smart controller 404, an operating room light adapter smart controller 403, and/or a monitor adapter controller 402, according to embodiments of the present disclosure. The service level layer 440 may include a routing service 445, a media service 446, an authorization service 447, a data exchange service 448, a service registry 449, a worklist service 441, a video processing service 442, a device status report web service 443, and a patient information service 444, according to embodiments of the present disclosure. The service layer 440 may produce various instantiations such as picture archiving and communications system 452 (PACS), hospital information system 451 (HIS), and lightweight direct access protocols 450 (LDAP).

FIG. 4 provides a schematic view of the software module dependencies according to some embodiments. The application block 430 contains full featured applications, according to some embodiments. From a user perspective these applications are an interface for the underlying services which can be either directly invoked and bundled within the application or remotely called via network requests depending on the actual deployment, according to some embodiments. FIG. 4 shows the static software structure focusing on logical dependencies according to one embodiment of the present disclosure.

FIG. 2 shows the actual deployment of the defined modules depicted in FIG. 4 and their relation to hardware, interfaces and network communication, according to some embodiments of the present disclosure. Therefore, FIG. 2 illustrates a runtime view of the software components and their interaction, according to one example. The relation of software components to systems may be 1:N, meaning that each component may be deployed on a separate device or all software components can be operated on the same device in parallel, according to some embodiments of the present disclosure. Flexible deployments with subsets within that range may also be used. This type of arrangement may further employ a message broker, as described above, according to some embodiments. Based on the architecture approach, separating functionality into different layers and tiers, in combination with distributed deployment of instances, may provide distributed functionality across the infrastructure, thus providing implicit business logic and functionality to devices without the need to host such functionality internally, according to embodiments of the present disclosure.

According to some embodiments of the present disclosure, the interconnectivity of smart controllers and other devices is established by using TCP/IP as the underlying transmission protocol which runs on most available physical network infrastructures like, for example, Ethernet (copper, fiber), WiFi, Bluetooth, LTE, UMTS, GPRS, and GPS. According to some embodiments, Ethernet connectivity may reduce electromagnetic interference within the operating room environment, by eliminating certain wireless radio frequency communication, and may minimize electromagnetic interference when fiber optic connectivity is employed.

According to some embodiments, for machine to machine communication the standardized MQTT protocol has been largely adopted which supports but is not constrained to TCP/IP networks. For higher level communication HTTP (HTTPS for secure transmission) on top of TCP/IP is used which can be naturally used for browser communication and can be exploited for machine to machine communication following REST (representational state transfer) principles. Compared to MQTT there is a communication overhead which might have an impact on rapid lower level device communication with small payload but is considered acceptable on higher level communication generated by Web Services, according to some embodiments. DICOM and HL7 communication is based on TCP/IP as well which reduces the effort for infrastructure integration of existing hospital services, according to some embodiments. Technologies for using TCP/IP for transmission of video and audio are already available and will become more popular within the foreseeable future as well.

A message broker, for example message broker 260, receives messages from all attached systems, according to some embodiments. Each system can publish and/or listen for messages. Messages are identified by unique IDs and categorized by topics, according to some embodiments. Each system has a unique IDs as well, and can be addressed by those unique IDs within the network, according to some embodiments. For identification of systems using Ethernet communication the MAC address can be used which is typically unique by default. Systems can register themselves for listening for topics. If a message for a certain topic is received by the message broker, the message broker may send to all listeners. The message broker is even responsible to make sure that the message is received in case the listener is temporarily not available or the networks suffer from temporary failures. To avoid single point of failures the message broker may be redundant as well within the network. The MQTT via TCP/IP may be used as the protocol.

An input-output (“IO”) controller according to some embodiments of the present disclosure is a simple software module bridging analogue signals triggered by buttons and serial interfaces (RS232, I²C, SPI) used by 3^{rd} party devices (e.g. temperature sensor, humidity sensor, and/or the like) to the network, according to embodiments of the present disclosure. IO controllers are running on small embedded devices offering analogue and serial interfaces, according to some embodiments. The logic executed on the device itself may be constrained to add basic semantics like measuring units and filtering for smooth integration into the network. In some cases the IO controller triggers events within the network based on physical interaction like pressing a button or value changes of sensors, according to embodiments of the present disclosure.

A business service according to an embodiment of the present disclosure provides business functionality within the network to applications, other services, or third party applications. For data exchange REST/HTTP via TCP/IP is used providing more structured, aggregated and semantically enriched information compared to messages send via the message broker, according to some embodiments. They also incorporate additional data sources like databases, files, HIS, PACS, and/or the like. Because HTTP is used, services can be naturally consumed by browsers supporting usage of web oriented applications equally running on mobile devices and workstations. Among the services, the service registry has a role as the switching center of the smart network, and may keep track of all available services, smart and IO controllers. Each entity within the network registers itself within the service registry specifying provided and demanded functionality, according to one embodiment of the present disclosure. This allows modular and flexible wiring of components based on their provisions and demands of services with loose coupling, according to some embodiments. The available information within the network impacts other “listening” devices on the network, but does not impact the origin of the information or the actual manner in which the information is acquired, according to some embodiments. The service registry can maintain connectivity at runtime and rewire services in case one fails and another is capable of providing the same information, according to some embodiments. The service registry and the message broker address the same need for managing interconnectivity but on different levels of abstraction, according to some embodiments. Within the service layer the focus is on managing semantic functionality while the message broker focuses on delivery of messages without incorporating semantics, according to some embodiments.

A smart controller according to some embodiments of the present disclosure may be contrasted with basic input output controllers. In contrast to IO controllers, smart controllers have a higher autonomy according to embodiments of the present disclosure. They can be connected to third party components with more sophisticated and/or proprietary interfaces like room cameras, electronic operating room tables, and/or the like. They may also consume data of other smart controllers or IO controllers for direct interaction. In addition they may also function as execution environments for applications or business services directly supporting distributed infrastructures, according to embodiments of the present disclosure.

One example of a smart controller involves OR light adaptation. Different smart controllers may be developed according to the supported OR light, but each smart controller may be configured to offer the same interface or adapted protocol for network interaction. Therefore, interacting systems can use the same API independent of the vendor specific physical interface and API, according to some embodiments of the present disclosure.

Another example of a smart controller is a routing controller, according to embodiments of the present disclosure. The smart controller runs a web service for video routing which is used by applications like PRIME365. It abstracts away from the concrete video matrix and offers a homogeneous API to the application, according to some embodiments of the present disclosure. Additionally the smart controller can listen for an IO controller signalling a pressed button to change the video routing supporting use cases in which direct interaction with the main application PRIME365 may not be necessary, according to embodiments of the present disclosure.

Applications according to some embodiments of the present disclosure provide an interface for direct user interactions like standalone applications (PRIME365, SmartBar) or web applications (like Studio ECLIPSE). Applications can interact with services, smart controllers, and IO controllers using the service registry and the message broker directly, according to some embodiments of the present disclosure.

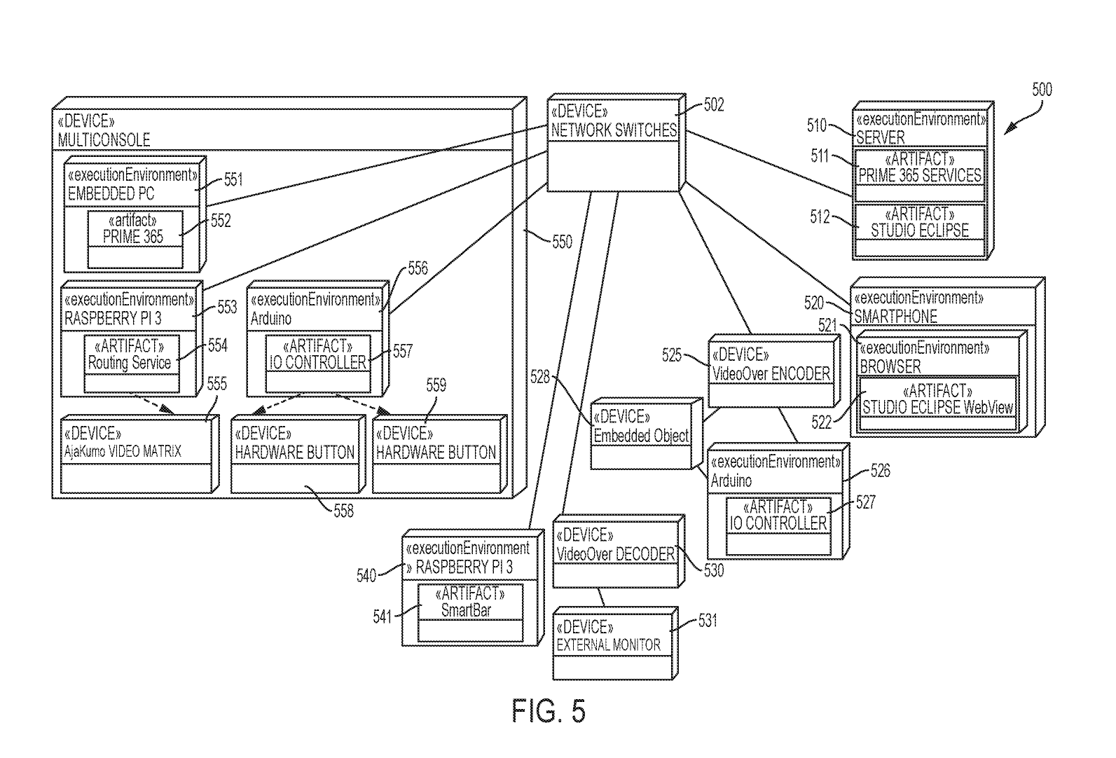

FIG. 5 illustrates a hardware deployment system 500 for the smart controller network of FIG. 4, according to embodiments of the present disclosure. Network switches 502 are communicably coupled with servers 510, smartphone execution environments 520, video over IP encoders 525, execution environments 526, endoscopes 528, video over IP decoders 530 (which may themselves be communicably coupled to external monitors 531), execution environments 540, and a multiconsole 550, which may itself include embedded devices and/or PCs 551, execution environments 553, and execution environments 556, according to embodiments of the present disclosure. The server execution environment 510 may include a prime 365 services artifact 511 and a studio eclipse artifact 512, according to embodiments of the present disclosure. The smartphone execution environment 520 may include a browser execution environment 521, which may include a Studio Eclipse Webview artifact 522, according to embodiments of the present disclosure. The execution environment 526, which may in some embodiments be an Arduino execution environment, may include an input output controller artifact 527, according to embodiments of the present disclosure. The execution environment 540, which may in some embodiments be a Raspberry PI 3 execution environment, may include a SmartBar artifact 541, according to embodiments of the present disclosure. The embedded PC execution environment 551 of the multiconsole device 550 may include a Prime 365 artifact 552, according to embodiments of the present disclosure. The Raspberry PI 3 execution environment 553 may include a routing service artifact 554, and may be communicably coupled to a video matrix device 555, according to embodiments of the present disclosure. The Arduino execution environment 556 of the multiconsole device 550 may include an input output controller artifact 557, and may be communicably coupled to a hardware button 558 and/or a hardware button 559, according to embodiments of the present disclosure.

As used herein, the term artifact is used in its broadest sense to refer to a software deliverable which can be deployed on a system. An artifact itself is not executed, but an artifact may be executed in combination with an execution environment like an embedded device or PC, and then becomes the runnable software component, according to an embodiment of the present disclosure. In other words, the software component may be instantiated. The same artifact can be deployed on different systems and can be altered via configuration, resulting in individual instantiations providing different functionality, according to some embodiments of the present disclosure. For example the IOController artifact is able to handle GPIOs but depending on the configuration and the connected hardware component, one concrete instantiation may be controlling a light while the other may be controlling a switch turning on another device, according to some embodiments of the present disclosure.

Although certain execution environments are described herein, the concepts of an input/output controller (e.g. “IOContoller”) and a smart controller (e.g. “SmartController” are not restricted to the usage of the Arduino and Raspberry PI execution environments.

From a hardware perspective, an IOController can be any embedded device, and may include one or more of the following features and/or characteristics, according to embodiments of the present disclosure:
inputs and outputs like GPIOs,
network interface,
a microprocessor and main memory sufficient for handling input/output in real-time and network transmission,
storage or memory for hosting the software artifact, and/or
an operating system, which might be present but may not be needed, as deployment of software as firmware is possible for controlling the complete microcontroller.

A SmartController may include one or more of the following features and/or characteristics, according to embodiments of the present disclosure, and in some cases may be a superset of those listed for the IOController:
more complex system using an operating system and supporting parallel execution of processes,
higher system requirements in terms of computation power and memory for more complex functionality like evaluation of rules, and/or
additional storage for persistence of internal status and temporary acquired data.

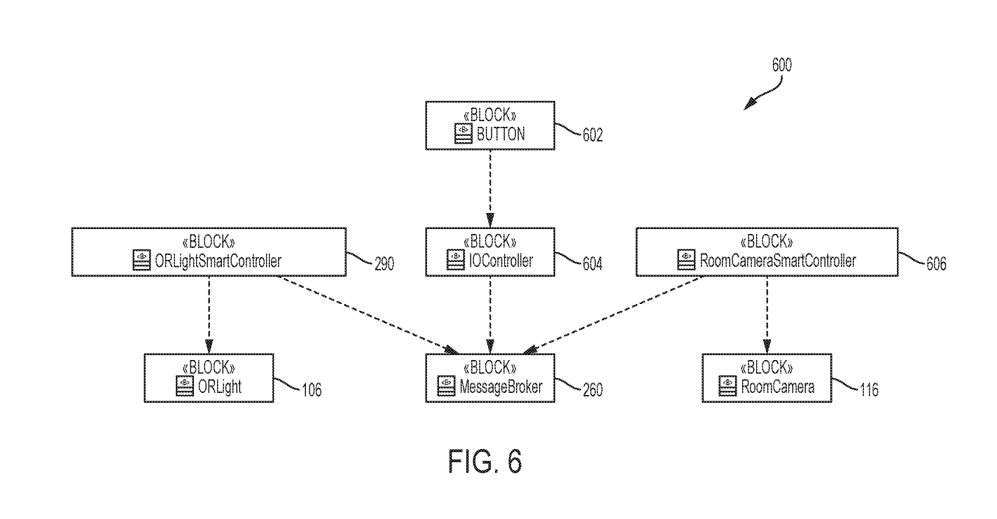

FIG. 6 illustrates a smart controller network 600 for an operating room light, a button, and an operating room camera, according to an embodiment of the present disclosure. The devices of FIG. 6 may be a subset of a larger set of devices and/or networked controllers, according to some embodiments. The system or network 600 includes a button 602, an input output controller 604, a message broker 260, a room camera smart controller 606, a room camera 116, an operating room light smart controller 290, and an operating room light 106, according to embodiments of the present disclosure. Button 602 may be a hardware button, a software button, or a combination hardware/software button or selection, according to embodiments of the present disclosure. Button 602 could be, for example, button 231 of a human input device input/output controller 230 of FIG. 2, according to one embodiment. Controller 604 may be an input/output controller, similar to an input/output controller that is proprietary to, or that would normally accompany a legacy button type device; alternatively, controller 604 may be a smart controller with autonomous functionality as described herein, according to embodiments of the present disclosure.

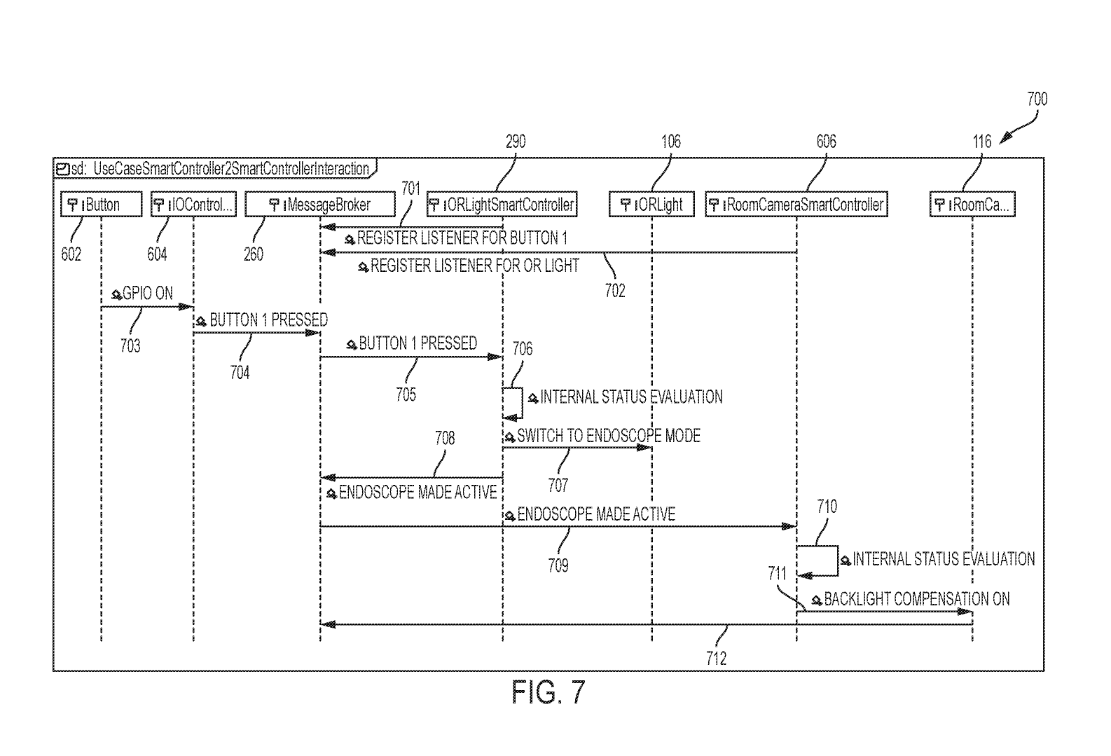

FIGS. 6 and 7 illustrate the communication and alignment of autonomous devices using smart controllers evaluating the operating room (“OR”) theatre conditions without involving a central control unit, according to embodiments of the present disclosure. The light mode change of an OR light 106 affects the overall light situation in the OR environment, causing effects for the image processing of the room camera 116. Depending on the phase of a procedure the OR light 106 is set to endoscope mode to optimize the light focus for the surgeon 118. In this scenario the overall light situation change implies backlight compensation for the room camera 116 to maintain good quality of video procession. Smart controllers may be embedded computation units controlling devices like OR lights 106, cameras 116, and/or the like. In combination with a message broker 260 they can share current status or their status transition with other smart controllers within the network, for example within the same local area network. The input output controller 604 can react on signals and publish this information to the network 114 but in contrast to smart controllers, in some embodiments a regular input output controller does not maintain an internal model of the environment. Message transmission may be handled via a message broker 260 decoupling the direct communication of each smart controller or input output controller, which supports extensibility and robustness.

FIG. 7 illustrates a messaging diagram 700 for an interaction among the controllers and smart controllers of FIG. 6, according to an embodiment of the present disclosure. According to some embodiments of the present disclosure, the underlying communication paradigm is publish-subscribe, which means that each controller registers itself as a listener for messages relevant to it. For example, smart controller 290 sends message 701 to the message broker 260 to register to listen for the button 602, and the room camera smart controller 606 sends message 702 to the message broker 260 to register to listen for the operating room light 106 messages. As described herein, the message broker 260 may be hardware, software, a combination of hardware and software, and may be part of a controller, smart controller, and/or distributed across two or more controllers and/or smart controllers such that its functionality described herein is performed by several different devices and/or software elements, according to embodiments of the present disclosure. A button 602 is connected to a general purpose input output controller 604. When the button 602 is pressed, the general purpose input output on the embedded device running the controller 604 detects a rising edge of the signal which is interpreted as the button 602 being pressed. It sends a message 703 to the input output controller 604, which sends a message 704 to the message broker 260 indicating the status transition from “unpressed” to “pressed” of that button 602.

The message broker 260 publishes this information to the OR light smart controller 290 via message 705. which registered itself before as listener for “Button 1” related messages. The OR light smart controller 290 interprets the received message, updates its internal model, evaluates the model and the predefined conditions and resolves one or more actions, shown at step 706. The resolved action in this particular example may be functionally described as “switching OR light to endoscope mode.” The OR light smart controller 290 uses the proprietary application programming interface (API) of the directly connected OR Light 106 (which may be, for example, an RS232 connection) to switch to endoscope mode (as indicated by message 707). After the mode is set, the OR light smart controller 290 publishes the message 708 that the OR light 106 is now in endoscope mode to the message broker 260. The message broker publishes the message 709 to the room camera smart controller 606, which registered itself before as a listener for “OR light” related messages.

The room camera smart controller 606 interprets the received message regarding the active endoscope mode of the OR light, updates its internal model, evaluates the model and the predefined conditions and resolves one or more actions, as shown at step 710, according to embodiments of the present disclosure. The resolved action in this particular example may be described as activating the backlight compensation mode of the room camera 116, according to embodiments of the present disclosure. The room camera smart controller 606 uses the proprietary API of the connected room camera 116 (which may be directly connected, for example via an RS232 connection) to activate backlight compensation, via message 711, according to some embodiments of the present disclosure.

In other words, a system 600 for decentralized control of fixtures in a medical care facility (e.g. an operating room 102 or hospital room) according to an embodiment of the present disclosure includes a first controller 290 configured to physically and communicably couple with a first device 106 and communicably coupled to a network (e.g. network hub 114, the internet, a local area network, and/or message broker 260 and other devices), the first device 106 physically coupled to, or self-contained in a sterile environment within, a medical care facility and configured to affect or observe physical conditions of the medical care facility. For example, the operating room light 106 is coupled to the operating room 102 and/or is self-contained within a sterile environment in the hospital or operating room 102, such that it performs its functions without contaminating the sterile environment. It is configured to affect the physical conditions of the operating room 102 by affecting the amount of light in the operating room 102, according to some embodiments. Such a system 600 may further include a second controller 606 configured to physically and communicably couple with a second device 116 and communicably coupled to the network (e.g. network hub 114, the internet, a local area network, and/or message broker 260 and other devices), the second device physically coupled to, or self-contained in a sterile environment within, the medical care facility and configured to affect or observe physical conditions of the medical care facility. The room camera 116 is configured to observe physical conditions of the operating room 102, according to embodiments of the present disclosure.

Such a system 600 may further include a message broker 260 communicably coupled to the network (e.g. network hub 114) and to the first 290 and second 606 controllers, the message broker 260 configured to receive all messages sent by the first controller 290 and the second controller 606 and to broadcast any such messages to the network 114, according to embodiments of the present disclosure. The first controller 290 may be configured for autonomous operation, whereby it is configured to control operation of the first device 106 and observe parameter changes in the first device 106 (for example the turning off or on of the light 106 and/or dimming of the light 106). The first controller 290 may be further configured to receive messages broadcast by the message broker 260 and determine, for each message, whether the first controller 290 has instructions for controlling the operation of the first device 160 based on the message. For example, the first controller 290 may be configured to receive messages such as message 705 broadcast by the message broker 260 indicating that a button, for example an endoscope button has been pressed, and determine (e.g. at step 706) whether first controller 290 has any instructions for controlling the first device 106 based on the message 705. First controller 290 may be further configured to, based on an affirmative determination (e.g. based on a determination that the smart controller 290 has instructions for switching the device 106 to endoscope mode when the button 602 is pushed), control the first device based on the message (e.g. switching the operating room light 106 to endoscope mode). The first controller 290 may be further configured to send messages to the message broker 260 indicative of the parameter changes in the first device 106 (for example, sending message 708 to the message broker 260 indicating that the endoscope mode of the operating room light 106 is now active).

The second controller 606 in such a system may be configured for autonomous operation, whereby the second controller is configured to control operation of the second device 116 and observe parameter changes in the second device 116, for example determining whether backlight compensation is on for the room camera 116. The second controller 606 may be further configured to receive messages broadcast by the message broker 260 and determine, for each message, whether the second controller 606 has instructions for controlling the operation of the second device 116 based on the message, and based on an affirmative determination, controlling the second device 116 based on the message. For example, the second controller 606 receives the message 709 broadcast by the message broker 260 indicating that the endoscope mode of the operating room light 106 is active, determines whether it has instructions for controlling the second device 116 based on the message 709 (e.g. via its internal status evaluation of step 710), and, based on an affirmative determination that controller 606 has instructions for adjusting the backlight compensation of the room camera 116 based on the message 709 that the endoscope mode of the operating room light 106 is active, the controller 606 sets a backlight compensation setting of the room camera 116 to on (e.g. via message 711). The second controller 606 may be further configured to send messages to the message broker 260 indicative of the parameter changes in the second device 116, for example sending message 712 to message broker 260 indicating that backlight compensation for the room camera 116 has been activated, according to embodiments of the present disclosure.

According to some embodiments of the present disclosure, the first controller 290 is independent of the second controller 606 and is configured to operate regardless of a presence of the second controller 606. In some cases, the first device 106 is physically and communicably coupled to the first controller 290, and the first device 106 is communicably coupled to the network (e.g. network hub 114, which may be a local area network of the hospital in which the operating room 102 is located) only via the first controller 290. In some embodiments, the second device 116 is physically and communicably coupled to the second controller 606, and the second device 116 is communicably coupled to the network (e.g. network hub 114, which may be a local area network of the hospital in which the operating room 102 is located) only via the second controller 606. As discussed above, the first device may be a lighting fixture 106 configured to light at least a portion of the medical care facility. As also discussed above, the second device 116 may be a camera configured to capture images of the at least the portion of the medical care facility, for example still images or video or sets of images that convey video resolution, according to embodiments of the present disclosure.

According to some embodiments of the present disclosure, the parameter changes in the first device 106 comprise a change in light intensity, and the first controller 290 is configured to send a message 708 to the message broker 260 indicating the change in light intensity, wherein the message broker 260 is configured to broadcast the message 709, and wherein the second controller 606 is configured to determine that the second controller 606 has instructions for controlling the operation of the camera 116 based on the message 709, and adjust a lighting compensation parameter 711 of the camera 116 based on the message 709.

According to some embodiments, a smart controller is a combination of hardware and software on which multiple applications can be deployed, and a controller to controller communication can occur, for example without a message broker (and/or with the message broker and/or its functionality being included by one or multiple smart controllers). In this scenario on one or even on both controllers the message broker could be deployed, according to one embodiment. In architectures with a large amount of clients, having a message broker 260 can serve to decouple the controllers from each other, which increases the robustness and scalability of the whole infrastructure. Using a message broker 260 can, according to some embodiments, prevent a need for each controller to know the presence and address of every other controller in the network to which it wants to send data.

According to some embodiments of the present disclosure, controllers exchange messages containing events characterizing internal or external status transition, instead of relying upon commands sent by a master control unit. In this manner, controllers share status information in a decentralized manner for enriching the model of the OR environment; according to such embodiments, no single controller is able to sense the environment fully because of missing information and the complexity of acquiring all needed information. An embodiment of the present disclosure employs a set of smart controllers that each focuses on its own individual task, making the network more manageable, with the computing power and storage capabilities of embedded devices being sufficient to accomplish the task, according to embodiments of the present disclosure. By sharing the result of its own actions plus additional sensed information, it provides valuable information to other systems pruning the individual effort to create an adequate knowledge base, according to embodiments of the present disclosure. Because a variety of information is available within the shared knowledge across the controllers, the deductive reasoning performed by each smart controller is more context-aware and efficient, according to embodiments of the present disclosure.

Use of autonomous controllers and/or smart controllers is more robust because specific adaption to improve the behavior can be optimized within a substructure without affecting the complete infrastructure, according to some embodiments. For example, if the low level conditions evaluated for specific actions are revised it will be only done on one controller while the others are still running and performing their work. Raising the level of abstraction for communicating information across controllers reduces the ripple effect of implementation changes within the overall infrastructure, according to some embodiments of the present disclosure.

According to some embodiments, each controller maintains its own knowledge base which is populated with status events acquired via sensors, direct interaction (e.g. manual change of light intensity via a hardware button on the device itself) or provided information from other controllers via the message communication infrastructure. According to one embodiment, in the absence of any inputs, the controller will not act because as long as no changes are applied to the knowledge base, the controller's evaluation or “listening” will not detect any actions to perform.

Using its direct interfaces like sensors and haptic controls, the controller may already be able to react and cause effects, by performing a simple sense-act cycle. Persisting the sequence of interactions in the internal model of the controller basic planning and reasoning extends the capabilities to a sense-plan-act cycle based on local information, according to some embodiments of the present disclosure. With connection to the mesh of controllers sharing their perceived environment, the sense-plan-act cycle becomes based on global information of the network, according to embodiments of the present disclosure.

Because of the distributed characteristics of an approach that makes controllers autonomous by imparting each controller with minimal additional complexity in perceiving the state of the environment, the whole system is able to scale better in terms of feature evolution, according to embodiments of the present disclosure. Adding additional controllers to an existing infrastructure is also much easier because the filtering of received information is done on the receiving side by registering for information, according to such embodiments. In such cases, the new sensor has no need to know which controllers consume the information, or the identity or location of those controllers that consumer the information, in order to be added to the network. This approach may also increase overall robustness. Even if parts of the smart controller mesh fail because of a network issue or for maintenance reasons, the remaining available controllers are still able to perform basic actions, according to embodiments of the present disclosure.

With available network technology, sending messages scales well regarding parallelism while parallel computing on the same hardware is more challenging because of needed synchronization and sequential resource usage, according to some embodiments. Distributing the computational power and localizing reasoning and acting increases the overall throughput of the whole system, according to some embodiments.

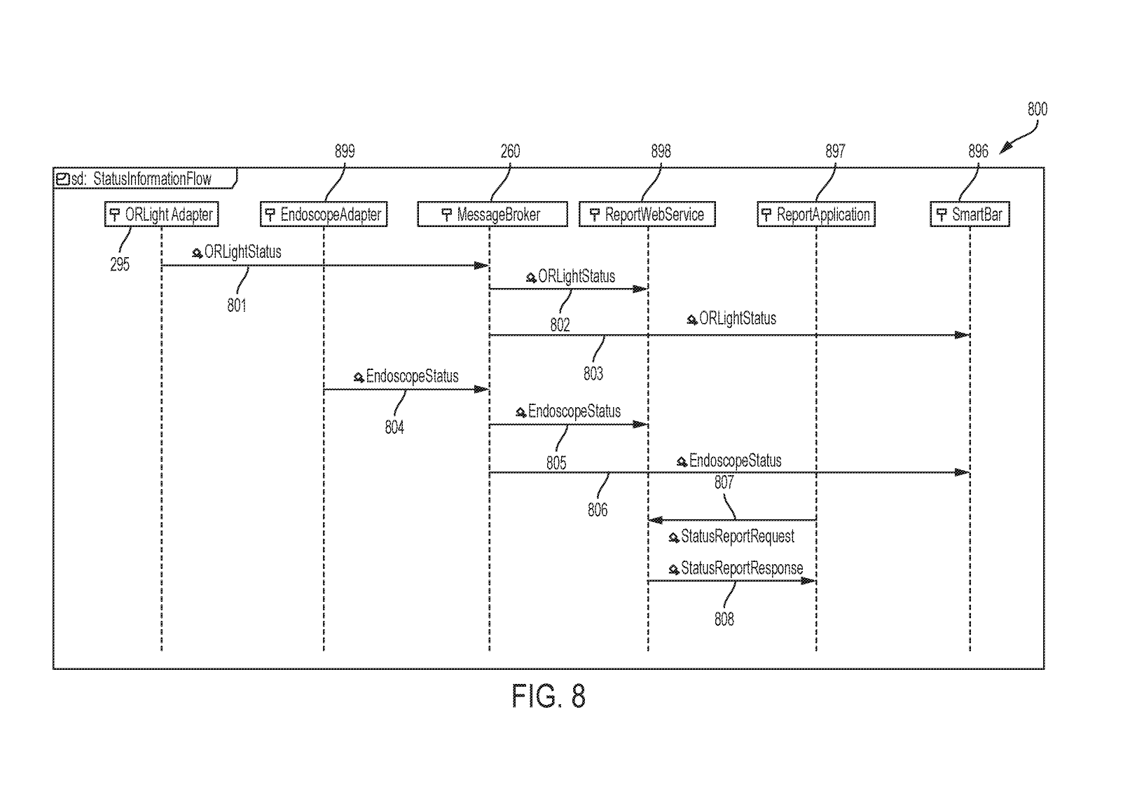

FIG. 8 illustrates a messaging diagram 800 for another interaction among smart controllers, according to an embodiment of the present disclosure. According to some embodiments of the present disclosure, each device within the OR (e.g. light, endoscope, table) is connected with a smart device running software which bridges the proprietary device interface to the network. Device specific control mechanism, data interpretation and physical connection is completely encapsulated within the smart device. The responsibility of the device is to acquire, structure and enrich data to avoid ambiguities and support interpretation, according to embodiments of the present disclosure. Afterwards the data is published to the network for further processing, storage and visualisation. As shown in FIG. 8, data is acquired from the OR light 295 and the endoscope 899 via different smart devices running adapter software for each device. The data is pre-processed and then send as status messages 801 to the message broker 260. A report web service 898 is registered within the message broker for receiving information from the OR light 295 and endoscope 899. The service 898 accumulates information over a time interval and across sources for generation of a status report covering all available devices. This status report is published to the report application 897 for display within a browser. In parallel the SmartBar 896 is also registered with the message broker 260 for the status information of the OR light 295 and the endoscope 899. While the report web service 898 is still collecting information to generate a report, the SmartBar 896 shows the current values directly and updates with every fresh data set provided by OR light 295 and endoscope adapters 899, according to embodiments of the present disclosure. These various messages 801, 802, 803, 804, 805, 806, 807, and 808 are sent between devices and/or to and from the message broker 260 according to a listen—publish—listen process, according to some embodiments of the present disclosure.

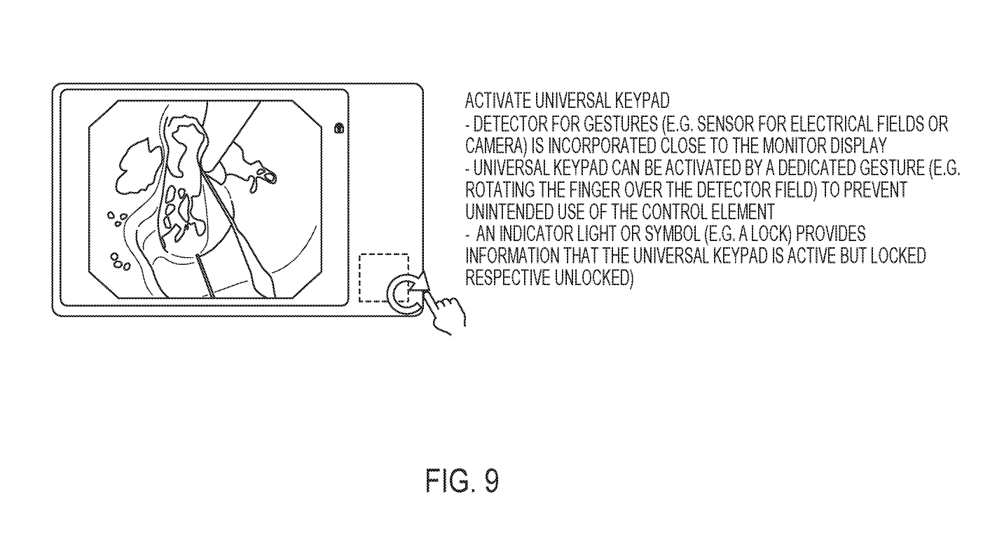

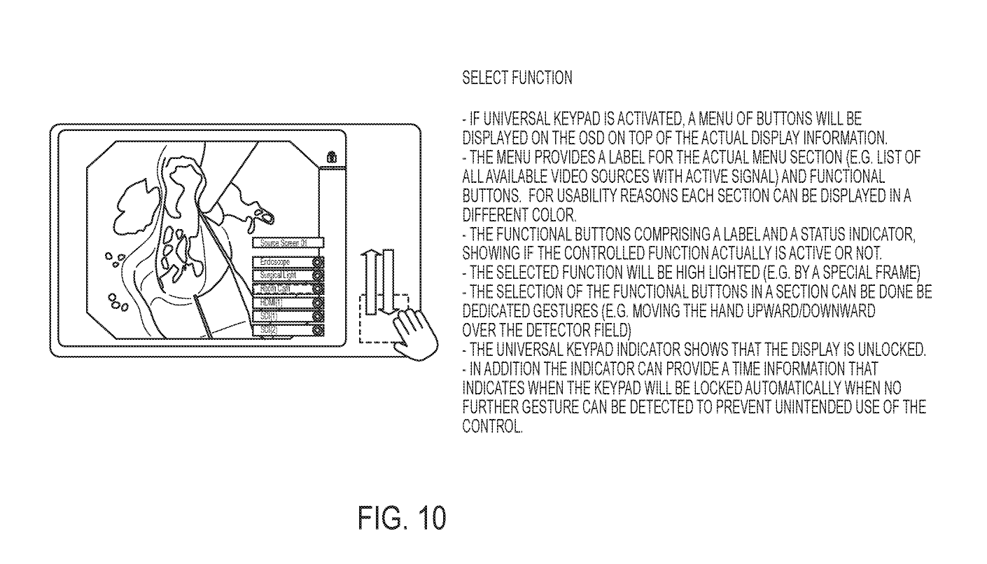

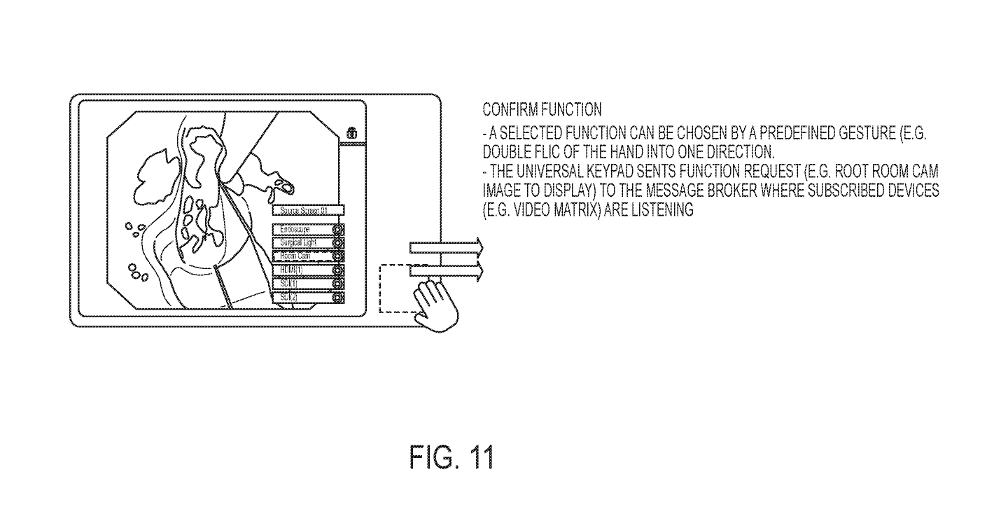

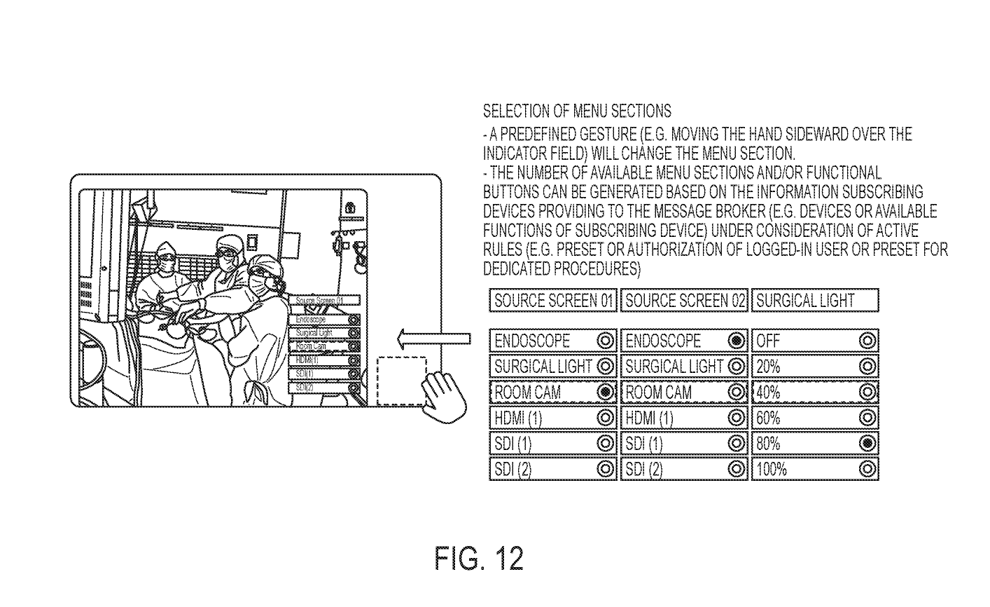

FIGS. 9-12 illustrate a user interface control for a universal keypad in an operating room environment using gesture controls, according to an embodiment of the present disclosure. The user interface shown in FIGS. 9-12 may be, for example, communicably coupled to the HID gesture input output controller 240 of FIG. 2. FIGS. 9-12 show and describe how various gestures can be used to activate certain buttons or settings or to change the information being viewed by the display, according to embodiments of the present disclosure.

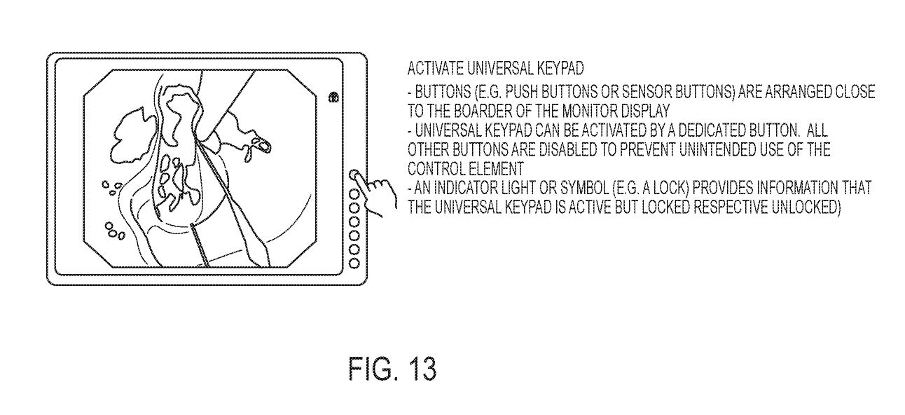

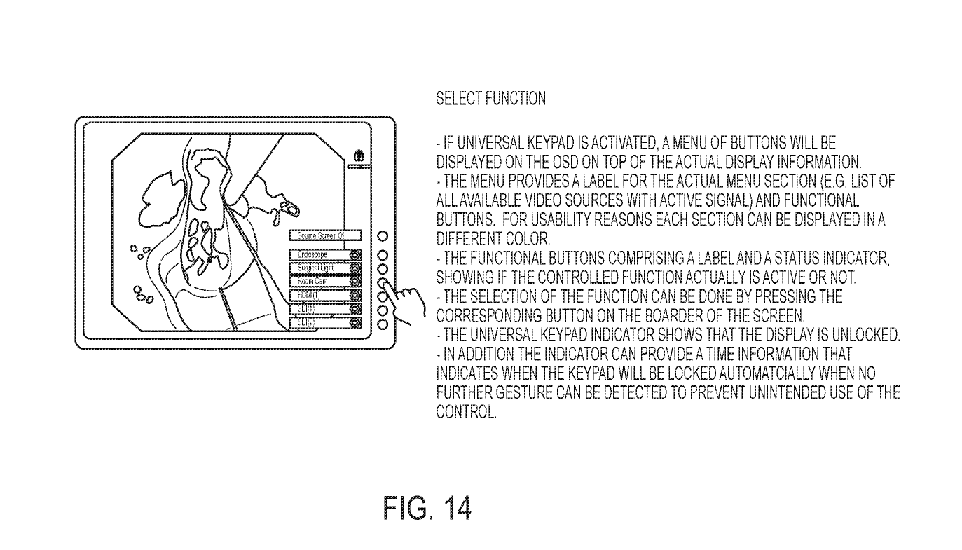

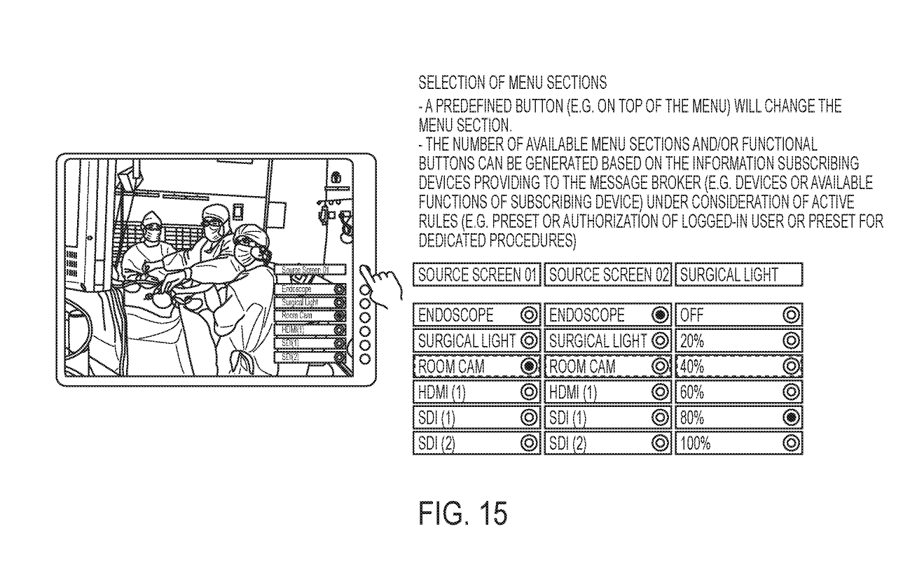

FIGS. 13-15 illustrate a user interface control for a universal keypad in an operating room environment using button pushes, according to an embodiment of the present disclosure. The user interface shown in FIGS. 13-15 may be, for example, communicably coupled to the HID button input output controller 230 of FIG. 2. FIGS. 13-15 show and describe how various button pushes (e.g. hardware buttons and/or software buttons) can be used to activate certain buttons or settings or to change the information being viewed by the display, according to embodiments of the present disclosure.

Exhibit A attached to U.S. Provisional Patent Application Ser. No. 62/420,357, filed on Nov. 10, 2016 (“Exhibit A”), which is incorporated by reference in its entirety for all purposes, illustrates a use case scenario for smart controllers in the context of a daily start check routine. Exhibit A describes a startup routine, and how different smart controllers for two different surgical lights and surgical cameras manufactured by two different manufacturers (e.g. SIMEON Medical and Trumpf Medical) listen for the start check messages, adapt the start check messages to the particular devices with which they are associated and which they control, and which messages they listen for and/or publish in the process. According to some embodiments of the present disclosure, the intelligence for initiating the daily start check messages may reside with rule engine 270 (see FIG. 3), which may have within its storage unit 273 instructions for execution by the logic unit 272 or processor to trigger the Devices.SurgicalLights.Action=StartCheck and Devices.SurgicalCamera.Action=StartCheck messages at a certain time (e.g. 6:00 am), with such messages being sent via network interface 271 to network hub 114 and hence to message broker 260 via network interface 261. The routines and processes described in Exhibit A are just one example and are not limiting of any embodiments. Start checks and smart controllers may operate according to numerous other and different routines, according to embodiments of the present disclosure.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for decentralized control of fixtures in a medical care facility, the system comprising:
a first controller configured to physically and communicably couple with a first device and communicably coupled to a network, the first device physically coupled to, or self-contained in a sterile environment within, a medical care facility and configured to affect or observe physical conditions of the medical care facility;
a second controller configured to physically and communicably couple with a second device and communicably coupled to the network, the second device physically coupled to, or self-contained in a sterile environment within, the medical care facility and configured to affect or observe physical conditions of the medical care facility; and
a message broker communicably coupled to the network and to the first and second controllers, the message broker configured to receive all messages sent by the first controller and the second controller and to broadcast any such messages to the network;
the first controller configured for autonomous operation, the first controller is configured to:
control operation of the first device;
observe parameter changes in the first device;
receive messages broadcast by the message broker and determine, for each message, whether the first controller has instructions for controlling the operation of the first device based on the message, and based on an affirmative determination, controlling the first device based on the message; and
send messages to the message broker indicative of the parameter changes in the first device;
the second controller configured for autonomous operation, the second controller is configured to:
control operation of the second device;
observe parameter changes in the second device;
receive messages broadcast by the message broker and determine, for each message, whether the second controller has instructions for controlling the operation of the second device based on the message, and based on an affirmative determination, controlling the second device based on the message; and
send messages to the message broker indicative of the parameter changes in the second device.

2. The system of claim 1, wherein the first controller is independent of the second controller and is configured to operate regardless of a presence of the second controller.

3. The system of claim 1, wherein the network is a local area network in the medical care facility.

4. The system of claim 1, further comprising the first device physically and communicably coupled to the first controller, wherein the first device is communicably coupled to the network only via the first controller.

5. The system of claim 4, further comprising the second device physically and communicably coupled to the second controller, wherein the second device is communicably coupled to the network only via the second controller.

6. The system of claim 1, wherein the first device is a lighting fixture configured to light at least a portion of the medical care facility.

7. The system of claim 6, wherein the second device is a camera configured to capture images of the at least the portion of the medical care facility.

8. The system of claim 7, wherein the parameter changes in the first device comprise a change in light intensity, and wherein the first controller is configured to send a message to the message broker indicating the change in light intensity, wherein the message broker is configured to broadcast the message, and wherein the second controller is configured to:
determine that the second controller has instructions for controlling the operation of the camera based on the message, and
adjust a lighting compensation parameter of the camera based on the message.

9. A controller for decentralized control of fixtures in a medical care facility, the controller comprising:
a housing that is self-contained in a sterile environment of the medical care facility;
a network interface contained by the housing, the network interface configured to communicably couple with a network;
a device interface contained by the housing, the device interface configured to physically and communicably couple with a device that is physically coupled to, or self-contained in a sterile environment in, a medical care facility and configured to affect or observe physical conditions of the medical care facility;
a processor communicably coupled to the network interface, the device interface, and a memory, the processor configured for autonomous operation, the memory including instructions that, when executed by the processor, cause the processor to:
receive a broadcast message from the network via the network interface;
determine whether the instructions include instructions for controlling the operation of the device based on the message;
based on an affirmative determination, adapting the message to an adapted message in a protocol that is specific to the device; and
controlling the device by sending the adapted message to the device via the device interface.

10. A method for decentralized control of fixtures in a medical care facility, the method comprising:
physically and communicably coupling a first controller to a first device and communicably coupling the first controller to a network, the first device physically coupled to, or self-contained in a sterile environment within, a medical care facility and configured to affect or observe physical conditions of the medical care facility;
physically and communicably coupling a second controller configured to a second device and communicably coupling the second controller to the network, the second device physically coupled to, or self-contained in a sterile environment within, the medical care facility and configured to affect or observe physical conditions of the medical care facility; and
communicably coupling a message broker to the network and to the first and second controllers, the message broker configured to receive all messages sent by the first controller and the second controller and to broadcast any such messages to the network;
receiving messages broadcast by the message broker at the first controller, and determining, for each message, whether the first controller has instructions for controlling the operation of the first device based on the message, and based on a positive determination, controlling the first device based on the message;
receiving messages broadcast by the message broker at the second controller, and determining, for each message, whether the second controller has instructions for controlling the operation of the second device based on the message, and based on a positive determination, controlling the second device based on the message,
wherein the first and second controllers operate autonomously, redundantly and without reliance on one another, by listening for and processing messages from the message broker, and by publishing messages to the message broker indicative of operation of their respective first and second devices.

11. The method of claim 10, wherein the network is a local area network in the medical care facility.

12. The method of claim 10, further comprising communicably coupling the first device to the network only via the first controller.

13. The method of claim 12, further comprising communicably coupling the second device to the network only via the second controller.

14. The method of claim 10, wherein the first device is a lighting fixture configured to light at least a portion of the medical care facility.

15. The method of claim 14, wherein the second device is a camera configured to capture images of the at least the portion of the medical care facility.

16. The method of claim 15, further comprising:
publishing a message to the network with the first controller indicating a change in light intensity of the lighting fixture;
receiving the message with the message broker;
broadcasting the message to the network with the message broker;
receiving the broadcast message at the second controller;
determining that the second controller has instructions for controlling the operation of the camera based on the message, and
adjust a lighting compensation parameter of the camera based on the message.
